(19) United States
(12) Patent Application Publication
(10) Pub. No.: US 2025/0315250 A1
(43) Pub. Date: Oct. 9, 2025

(54) UPGRADING APPLICATIONS WITH SERVICES

(71) Applicant: Snowflake Inc., Bozeman, MT (US)

(72) Inventors: Benoit Dageville, San Mateo, CA (US); Scott C. Gray, Richmond Hill (CA); Unmesh Jagtap, San Mateo, CA (US); Eduardo A.G.C. Laureano, Bellevue, WA (US); David Taylor, San Francisco, CA (US)

(21) Appl. No.: 18/630,916

(22) Filed: Apr. 9, 2024

(51) Int. Cl. G06F 8/656; G06F 8/71

(52) U.S. Cl. CPC G06F 8/656; G06F 8/71

(57) ABSTRACT

A data platform that upgrades applications having containerized services across multiple consumer user accounts when the data platform receives a new version from a provider user. For each consumer account utilizing the application, the data platform performs a series of upgrade operations. The operations include identifying the relevant set of services linked to the application and executing an upgrade command for each service to transition to the new version. The data platform actively monitors the health and version status of each service, ensuring they meet the upgrade criteria. The upgrade is deemed successful and confirmed by the data platform once all services are verified to be healthy and aligned with the new version, thus ensuring a seamless and efficient upgrade experience.

### TECHNICAL FIELD

Examples of the disclosure relate generally to data platforms and, more specifically, to upgrading services provided by a data platform.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems. Users may develop applications that execute on data platforms.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider user system, according to some examples.

FIG. 2 is a block diagram illustrating components of a compute service manager, according to some examples.

FIG. 3 is a block diagram illustrating components of an execution platform, according to some examples.

FIG. 4A illustrates a container compute method, according to some examples.

FIG. 4B illustrates creation and execution of a container in a compute pool, according to some examples.

FIG. 5A illustrates an application upgrade method, according to some examples.

FIG. 5B illustrates an example application upgrade state diagram, according to some examples.

FIG. 6 illustrates a diagrammatic representation of a machine in the form of a computer system within which a set of instructions may be executed for causing the machine to perform any one or more of the methodologies discussed herein, according to some examples.

### DETAILED DESCRIPTION

Data platforms, which may be structured as on-premises or network-based systems like cloud-based data platforms, are utilized for a wide array of data storage and access operations. These platforms can support various data processing types, including Online Transactional Processing (OLTP), Online Analytical Processing (OLAP), or a combination thereof, and may comprise relational database management systems (RDBMS) or other database management systems.

A provider user of a data platform may develop applications that execute on a data platform owned by a data platform operator within the context of a consumer user account and it is desirable to upgrade these applications. An application may provide services, such as through distribution in a container or the like, that are to be upgraded from time-to-time. To do so, these upgrades may be advantageously performed in an asynchronous manner on a “live” system that spans multiple back-end services, ensuring that the upgrade process is seamless and does not disrupt the ongoing functionality and availability of the system to the consumer users.

In some examples, a data platform methodically upgrades applications by executing a series of operations that ensure a seamless transition to new versions. The data platform receives the new version from a provider user and initiates the upgrade process for each consumer user's application. This process includes identifying and executing upgrade commands for each associated service, monitoring their health and version statuses, and confirming the upgrade's success once all services are verified to be healthy and on the new version. The method provides that all services are synchronized with the latest version, thereby maintaining application integrity and continuity for consumer users.

The data platform enhances the upgrade process by providing notifications to the provider user upon completion, allowing consumer users to schedule upgrades within a specified window, and utilizing readiness probes for health checks. The data platform maintains operational stability by keeping the current version active until the upgrade is confirmed and swiftly reverts to a previous version in case of upgrade failure. The data platform also adheres to original service specifications from the application's manifest and sets wait time thresholds for service upgrades, considering an upgrade failed if the threshold is exceeded. By performing upgrades as part of a release directive and providing an application state view, the data platform offers a structured approach to deploying new versions and transparent oversight of the upgrade process.

In some examples, the data platform receives a new version for an application from a provider user and conducts a series of upgrade operations for each consumer user of the application. These operations involve the data platform determining a set of services associated with the application, executing an upgrade command for each service to transition to the new version, monitoring the health and version status of each service, and confirming the application upgrade after all services are verified to be healthy and on the new version.

In some examples, the data platform provides a notification to the provider user upon the completion of the application upgrade, ensuring that the provider is informed of the upgrade status.

In some examples, the data platform delays the application upgrade to allow a consumer user to schedule the application upgrade within a specified delay window, offering flexibility in upgrade timing to accommodate the consumer user's preferences or operational requirements.

In some examples, the data platform utilizes a readiness probe to determine the health status of each service during the monitoring phase, providing a reliable assessment of each service's readiness for the upgrade.

In some examples, the data platform maintains the current version of the application and the set of services in an operational state until the application upgrade is confirmed, ensuring service continuity during the upgrade process.

In some examples, the data platform reverts to a previous version of the application and the set of services in the case of an application upgrade failure, enabling a swift recovery to a stable state.

In some examples, the data platform applies original service specifications from a manifest associated with the current version of the application, ensuring consistency with the established configuration during the upgrade.

In some examples, the data platform sets a wait time threshold for the set of services to upgrade and considers the application upgrade failed when the wait time has exceeded the wait time threshold, enforcing a time-bound upgrade process.

In some examples, the data platform performs the application upgrade as part of a release directive issued to begin deploying the new version of the application, following a structured and authorized upgrade protocol.

In some examples, the data platform provides an application state view to the provider user, which includes details about the status of the application upgrade and the set of services, offering transparency and oversight of the upgrade process.

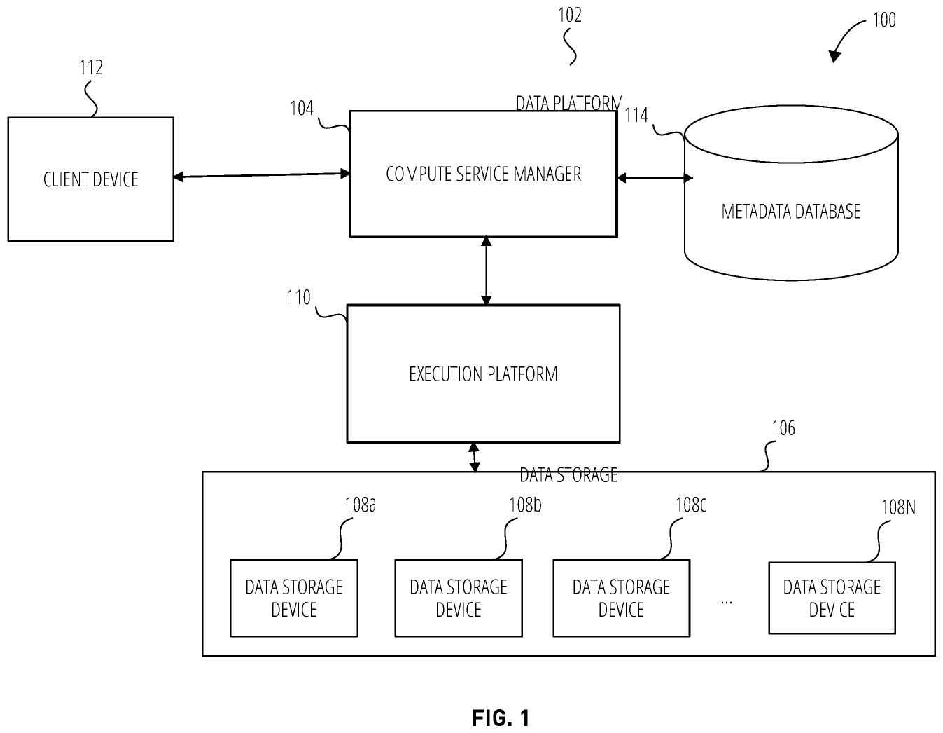

FIG. 1 illustrates an example computing environment 100 that includes a data platform 102 in communication with a client device 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage 106, a compute service manager 104, an execution platform 110, and a metadata database 114. The data storage 106 comprises a plurality of computing machines and provides on-demand computer system resources such as data storage and computing power to the data platform 102. As shown, the data storage 106 comprises multiple data storage devices, such as data storage device 108a, data storage device 108b, data storage device 108c, and data storage device 108N. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage 106 may include distributed file systems (e.g., Hadoop Distributed File Systems (HDFS)), object storage systems, and the like.

The data platform 102 is used for reporting and analysis of integrated data from one or more disparate sources including the storage devices 1 to N within the data storage 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage 106. Moreover, the data platform 102 may maintain metadata associated with the consumer accounts in the metadata database 114. Each consumer account includes multiple objects with examples including users, roles, privileges, a datastores or other data locations.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client device 112. The client device 112 can be used by a user of one of the multiple consumer accounts supported by the data platform 102 to interact with and utilize the functionality of the data platform 102. In some examples, the compute service manager 104 does not receive any direct communications from the client device 112 and only receives communications concerning jobs from a queue within the data platform 102.

The compute service manager 104 is also coupled to metadata database 114. The metadata database 114 stores data pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the database storage 106) and the local caches. In some examples, the metadata database 114 include data of metrics describing usage and access by provider users and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the database storage 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 108a to data storage device 108N are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata database 114, execution platform 110, and data storage 106 are shown in FIG. 1 as individual discrete components. However, each of the compute service manager 104, metadata database 114, execution platform 110, and data storage 106 may be implemented as a distributed system (e.g., distributed across multiple systems/platforms at multiple geographic locations). Additionally, each of the compute service manager 104, metadata database 114, execution platform 110, and data storage 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage 106. It is desirable to retrieve as much data as possible from caches within the execution platform 110 because the retrieval speed is typically faster than retrieving data from the data storage 106.

As shown in FIG. 1, the computing environment 100 separates the execution platform 110 from the data storage 106. In this arrangement, the processing resources and cache resources in the execution platform 110 operate independently of the database storage devices data storage device 108a to data storage device 108N in the data storage 106. Thus, the computing resources and cache resources are not restricted to a specific one of the data storage device 108a to data storage device 108N. Instead, computing resources and cache resources may retrieve data from, and store data to, any of the data storage resources in the data storage 106.

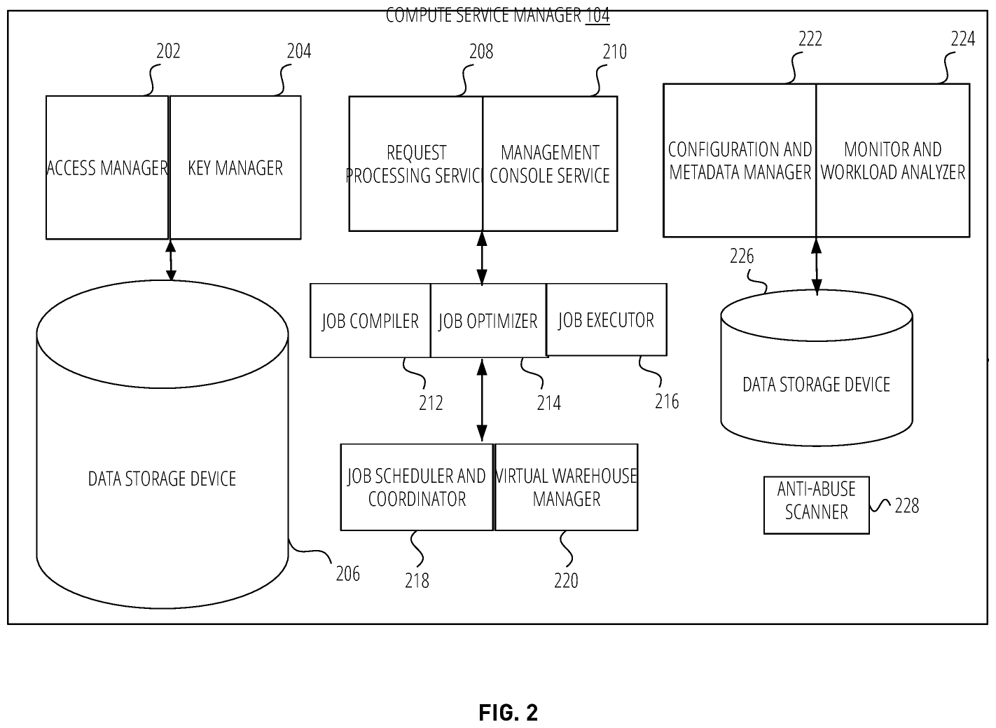

FIG. 2 is a block diagram illustrating components of the compute service manager 104, according to some examples. As shown in FIG. 2, the compute service manager 104 includes an access manager 202, and a key manager 204. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage data storage device 206). As used herein, the remote storage devices may also be referred to as “persistent storage devices” or “shared storage devices.”

In some examples, the access manager 202 operates within a data platform to control access to various objects of the data platform using Role-Based Access Control (RBAC). The access manager 202 is a component that manages authentication and authorization tasks, providing for authorized entities to access specific resources within the data platform. This component plays a role in maintaining the security and integrity of the data platform by enforcing access policies defined through RBAC.

In some examples, RBAC is implemented by defining roles within the data platform, where each role is associated with a specific set of permissions. These permissions determine the actions that entities assigned to the role can perform on various objects within the data platform. The access manager 202 utilizes these roles to make access control decisions, allowing or denying requests based on the roles assigned to the requesting entity and the permissions associated with those roles.

In some examples, the data platform creates specific access roles based on a manifest of an application received from an application package. These access roles are activated by the access manager 202 and are used to govern access to objects used by the application during operation. For example, an access role may grant the application the ability to create a compute pool and execute a service within that compute pool. The access manager 202 provides that an application, or entities authorized by the application, can perform actions permitted by the access role.

In some examples, the access manager 202 also controls access to objects of the data platform using the access roles during the execution of the service within the compute pool. The service accesses objects of the application package and of the data platform under the governance of the activated access roles. The access manager 202 checks the permissions associated with the access roles against the access requests made by the service, granting or denying these requests based on the defined RBAC policies.

In some examples, the role of the access manager 202 extends to managing access to hidden repositories within a provider account, where the application package is stored. The access manager 202 uses RBAC to restrict access to a hidden repository, providing for the application package to be accessible to entities with the appropriate access role. This mechanism protects the application package from unauthorized access, preserving the integrity of the provider's intellectual property.

In some examples, the access manager 202 implements RBAC to isolate the compute pool, preventing the service from accessing other services or resources not specified in the application package. This isolation is achieved by defining access roles that explicitly limit the service's permissions to the resources provided for the operation of the service, thereby enhancing the security of the service execution environment.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage 106, or any other storage device.

The compute service manager 104 validates communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 304a) may need to communicate with another execution node (e.g., execution node 304b), and should be disallowed from communicating with a third execution node (e.g., execution node 316a) and any such illicit communication can be recorded (e.g., in a log or other location). Also, the information stored on a given execution node is restricted to data relevant to the current query and any other data is unusable, rendered so by destruction or encryption where the key is unavailable.

The compute service manager 104 further comprises an anti-abuse scanner 228 that monitors creation of application packages created by content provider users of the data platform 102. When a new application package is created by a content provider user, the anti-abuse scanner 228 scans the application package to determine if the application package contains content that is harmful, malicious, and the like. If such content is found, the anti-abuse scanner 228 prevents release of the application package by the content provider user.

In some examples, the anti-abuse scanner 228 is a component of another system that the compute service manager 104 communicates with via a network of the like.

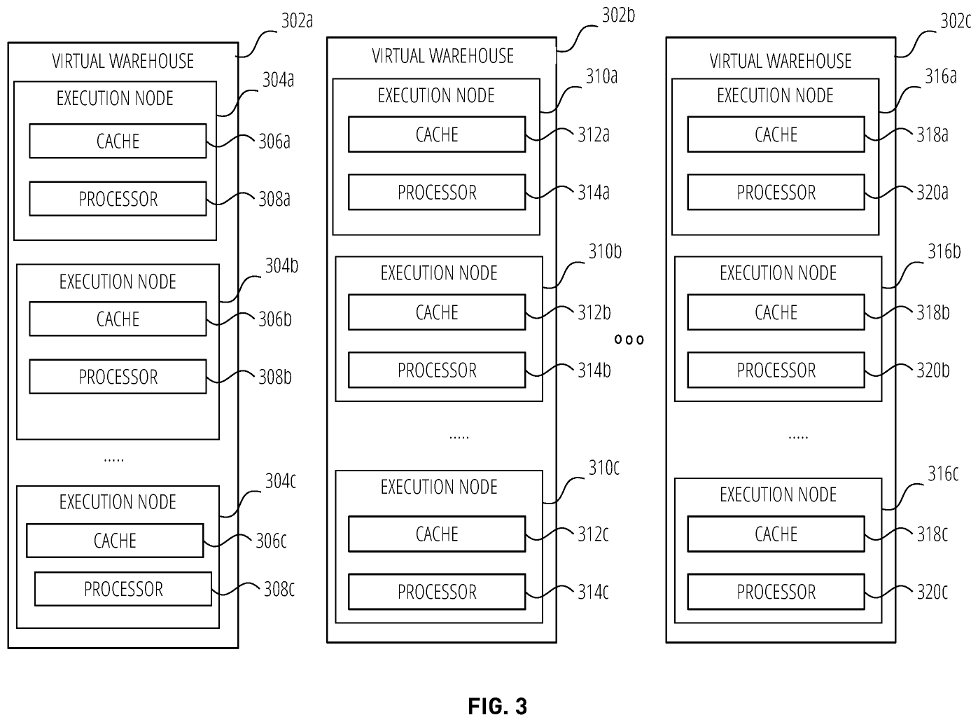

FIG. 3 is a block diagram illustrating components of the execution platform 110, according to some examples. As shown in FIG. 3, the execution platform 110 includes multiple virtual warehouses, including virtual warehouse 302a, and virtual warehouse 302b to virtual warehouse 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. Virtual warehouses can access data from any data storage device (e.g., any storage device in data storage 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 302a includes a plurality of execution nodes as exemplified by execution node 304a, execution node 304b, and execution node 304c. Execution node 304a includes cache 306a and a processor 308a. Execution node 304b includes cache 306b and processor 308b. Execution node 304c includes cache 306c and processor 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 302a discussed above, virtual warehouse 302b includes a plurality of execution nodes as exemplified by execution node 310a, execution node 310b, and execution node 310c. Execution node 304a includes cache 312a and processor 314a. Execution node 310b includes cache 312b and processor 314b. Execution node 310c includes cache 312c and processor 314c. Additionally, virtual warehouse 302c includes a plurality of execution nodes as exemplified by execution node 316a, execution node 316b, and execution node 316c. Execution node 316a includes cache 318a and processor 320a. Execution node 316b includes cache 318b and processor 320b. Execution node 316c includes cache 318c and processor 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 302a implements execution node 304a and execution node 304b on one computing platform at a geographic location and implements execution node 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

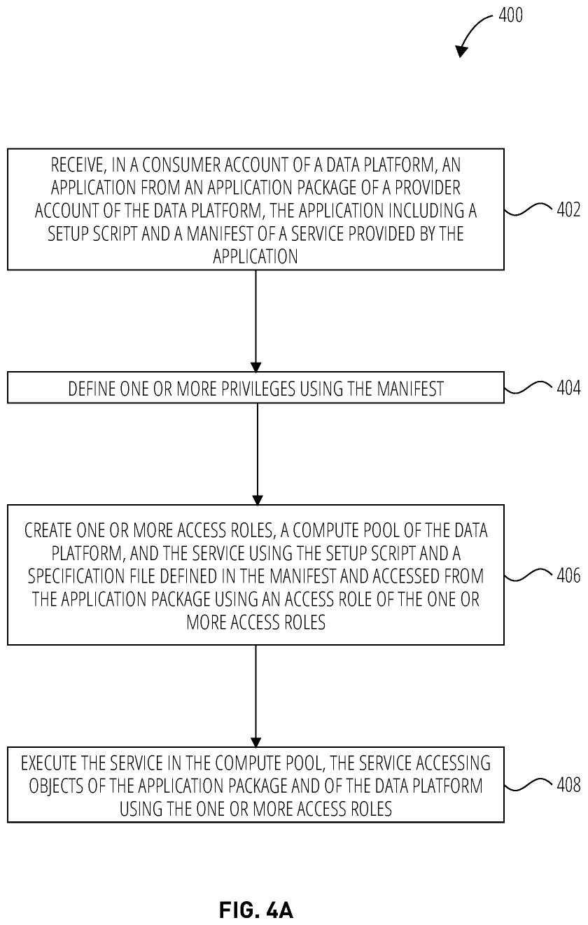

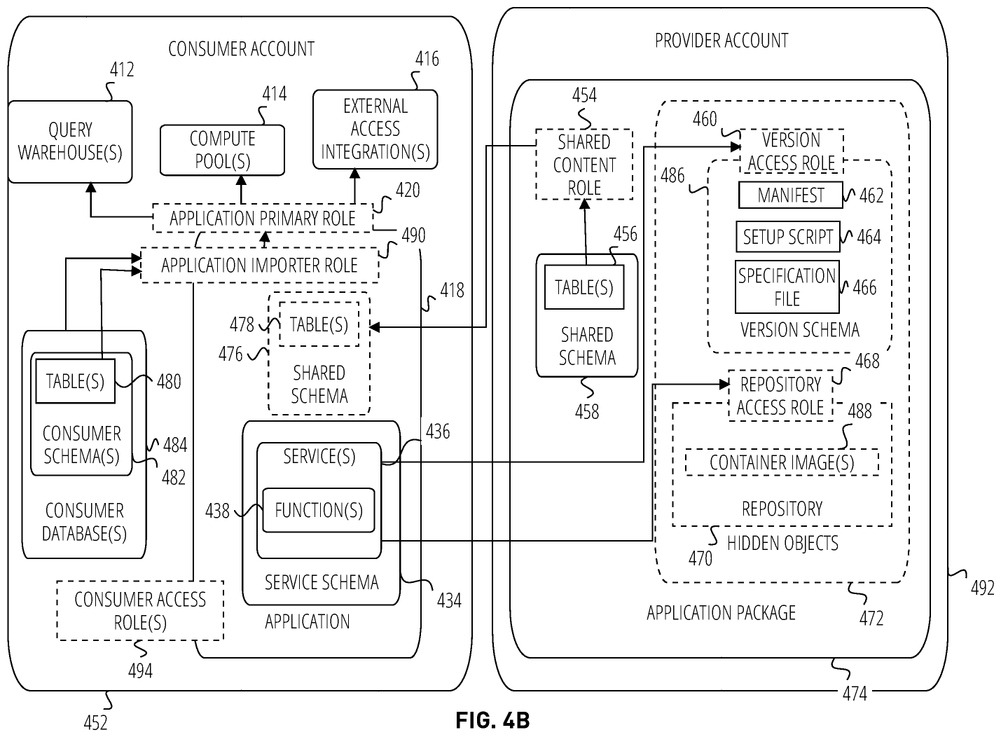

FIG. 4A illustrates an example container compute method 400 for controlling access of an application during execution on a data platform and FIG. 4B illustrates creation and execution of a container in a compute pool, according to some examples. Although the example container compute method 400 depicts a particular sequence of operations, the sequence may be altered without departing from the scope of the present disclosure. For example, some of the operations depicted may be performed in parallel or in a different sequence that does not materially affect the function of the container compute method 400. In other examples, different components of a data platform, such as data platform 102 of FIG. 1, that implement the container compute method 400 may perform functions at substantially the same time or in a specific sequence.

In operation 402, a consumer account 452 receives from a provider account 492 an instantiation of an application package 474. For a version of an application, the application version has a corresponding application package 474 including a version schema 486 having a manifest 462, a setup script 464, and one or more specification files, such as specification file 466, associated with a service schema 434. In some examples, an application 418 may have none or more service schemas. The service schema 434 includes one or more services 436 and functions 438.

In some examples, the services are distributed across various containers or similar encapsulated environments, which allows for modular deployment and scalable management of the application components within the data platform.

In some examples, the version schema 486 of the application package 474 may include other application support files including, but not limited to Java Archive (JAR) files, Python modules, data files, configuration files such as XML or JSON files, executable binaries for various operating systems, shell scripts for automation tasks, property files for application settings, libraries or dependencies of the application, SQL scripts for database setup or migration, documentation files such as READMEs or user guides, license files detailing the software's terms of use, and the like.

In some examples, the manifest 462 specifies one or more container images 488 of the service schema 434 and privileges granted to the application 418. A setup script 464 specified by the manifest 462 defines the one or more services 436 and functions 438. The manifest 462 and the setup script 464 enable automated deployment by providing a structured outline of a configuration, privileges, and resource dependencies of the application 418 and the one or more services 436 and functions 438 of the service schema 434.

In some examples, the manifest 462 includes metadata such as version information, which assists in tracking and managing different iterations of the application package 474 and installed application 418 over time.

In some examples, the manifest 462 lists artifacts that are part of the application package 474, such as the setup script 464 that includes instructions for creating and configuring the service schema 434. In some examples, the setup script 464 includes execution parameters for a service 436 (of FIG. 4B) of the service schema 434. The setup script 464 automates the creation of database objects, compute resources, and other setup tasks thus streamlining the deployment process of the service schema 434. The setup script is executed during the deployment, upgrading, and configuration of applications and their associated services within a data platform. The setup script is designed to automate the creation and configuration of various application components, such as services, compute pools, and query warehouses, as defined in the application manifest.

In some examples, aspects of a setup script include, but are not limited to:
Manifest Reference: The setup script is referenced in the application manifest, which outlines the configuration, privileges, and resource dependencies of the application. The manifest ensures that the service has the authorizations to function correctly once deployed.
Automated Deployment: The setup script contains instructions for creating database objects, compute resources, and other setup tasks, thereby streamlining the deployment process.
Role-Based Access Control (RBAC): The setup script defines RBAC roles that are granted to the application and to the consumer user who owns the application when installed. These roles include an application primary role, which isolates the application from the consumer user, and an application importer role, which allows the application to access consumer user-owned objects.
Service Creation: The setup script includes commands to create services within compute pools, specifying execution parameters and defining the environment in which services will execute.
Privilege Granting: It grants privileges to objects within the application to expose them to the consumer user, ensuring that the application components are accessible.
Hidden Objects: The setup script can access hidden objects, such as the version schema and repository, using specific access roles created by the data platform when the application package is created.
Consumer Access Roles: The script defines consumer access roles that are granted to the application owner, allowing the consumer user to grant these roles to other entities or objects within the data platform.
Execution: During the execution of the setup script, the data platform activates the appropriate roles based on the application version, granting the application access to resources.

In some examples, the setup script 464 specifies one or more BRAC roles that are granted to the application 418 and to a consumer user who is the owner of the application 418 when the application 418 is installed in the consumer account 452. For example, an application primary role 420 is a role that is managed by the data platform 102. In some examples, the application primary role 420 is created implicitly and granted to the application 418 by the data platform 102 when the application 418 is installed in the consumer account 452. Objects in the application 418 are owned by, and run as, the application primary role 420. The application primary role 420 isolates the application 418 from the consumer user and vice versa. In some examples, the one or more services 436 and one or more functions 438 run as the primary application role 420 and inherit access to the components of the application 418 and any components of the data platform 102 to which the 418 has also been granted access.

In some examples, the setup script 464 is executed during an upgrading process.

In some examples, an application importer role 490 is managed by the data platform 102 and is granted to the application primary role 420 by the data platform 102. In some examples, the application importer role 490 is created implicitly with the application 418 is installed in the consumer account 452. Permissions the consumer user gives to the application 418 are granted to the application importer role. This is how the application 418 is allowed access to the consumer user owned objects such as, but not limited to, the one or more tables 480 in the one or more consumer schemas 482 of the one or more consumer databases 484.

In some examples, one or more consumer access roles 494 are created by the setup script 464 and are granted to the consumer user who is the owner of the installed application 418. In some examples, the consumer user may regrant the consumer access roles 494 to other entities or objects within the execution environment. Via the setup script 464, the application 418 grants privileges to objects within the application 418 to the consumer access roles to expose the objects to the consumer user.

In some examples, the application 418 uses the application primary role 420 to create one or more query warehouses 412, create one or more compute pools 414, and access one or more external access integrations 416 of the data platform 102.

In some examples, the application primary role 420 is created and managed on behalf of the application 418 by a proprietor of the data platform 102 (of FIG. 1) that hosts the consumer account 452 and the provider account 492. The application primary role 420 owns objects within the application and code that execute in the application.

In some examples, the proprietor of the data platform 102 grants the application primary role 420 to the application 418.

In some examples, neither a consumer user having access to the consumer account 452 nor a provider user having access to the provider account 492 can be granted the application primary role 420.

In some examples, neither a consumer user having access to the consumer account 452 nor a provider user having access to the provider account 492 can grant the application primary role 420 to the application 418.

In some examples, in order for the application 418 to be able to create compute pools 414 and warehouses 412 (and other resources), a consumer user having access to the consumer account 452 grants these privileges to the application 418, this grant is conveyed to the application primary role 420 via an application importer role 490.

In some examples, the application 418 is granted an application importer role 490 used to access one or more consumer user objects such as, but not limited to, one or more consumer databases 484, consumer schemas 482, and consumer tables 480.

In some examples, the application importer role 490 is created by a proprietor of the data platform 102 that hosts the consumer account 452 and the provider account 492. The application importer role 490 is created as a hidden role on behalf of the application 418. The application importer role 490 is automatically granted to the application primary role 420. In order for the application 418 to access objects owned by the consumer user, the consumer grants access to the objects to the application 418 via the application importer role 490.

By declaring these parameters upfront, the manifest 462 provides that the service 436 has the authorizations to function correctly once deployed. An example manifest is illustrated below:

manifest_version: 1
version:
name: V1
artifacts:
readme: readme.md
setup_script: setup.sql
default_web_endpoint:
service: ux_schema.ux_service
endpoint: ui
images: - /database/schema/repository/image1
privileges:
- CREATE COMPUTE POOL description: ″...″
- CREATE WAREHOUSE description: “...”

In some examples, a consumer user explicitly grants or approves requested privileges. These requested privileges are declared in the manifest both to drive UI that helps with this process, but also to allow the consumer user to understand what privileges the application will use should it be installed (e.g., a consumer user may decline to install an application if they are unwilling to grant the application specified permissions).

In some examples, the specification file 466 specifies components and attributes of one or more container images 488 of the service schema 434. The one or more container images 488 are given as one or more paths to a repository 470 associated with the versioned schema 486 of the application package 474 and used for execution of the service schema 434. A portion of an example spec file is illustrated below:
spec:
container: - name: main
image: /database/schema/repository/image1
env: DATA_PLATFORM_WAREHOUSE: warehouse

In some examples, the setup script 464 is used to create and initiate execution of the one or more services 436 and functions 438. The setup script 464 creates and configures the one or more services 436 and functions 438.

In some examples, the setup script 464 defines one or more consumer access roles 494 that are granted to the application owner in the environment of the consumer user. The consumer user may then grant the one or more consumer access roles 494 to other entities or objects of the data platform. In some examples, any object that the setup script 464 associates to a consumer access role of the one or more consumer access roles 494 becomes visible to the consumer user. An example setup script is illustrated below:

CREATE CONSUMER ACCESS ROLE app_user;
CREATE COMPUTE POOL ″APP$POOL_1″ ...;
CREATE WAREHOUSE ″APP$QUERY_WH″ ...;
CREATE SCHEMA IF NOT EXISTS service;
GRANT USAGE ON SCHEMA service TO CONSUMER ACCESS
ROLE app_user;
CREATE SERVICE service.app_service
IN COMPUTE POOL “MY_APP$POOL_1”
QUERY_WAREHOUSE = ″APP$QUERY_WH″
SPECIFICATION_FILE = ′/spec.yaml′;
CREATE FUNCTION service.test(x string)
RETURNS string
SERVICE = service.app_service
ENDPOINT = test_endpoint AS ′/test′;
GRANT USAGE ON FUNCTION service.test(string) TO CONSUMER
APPLICATION ROLE app_user;

In some examples, the version schema 486 and the repository 470 are stored as hidden objects 472 within the provider account 492. Once an object is stored as a hidden object, a provider user who created the application package 474 cannot change the contents of the version schema 486 or the repository 470. However, the hidden version schema 486 and the contents of the repository 470, including the one or more container images 488, may be accessed by an entity using one or more access roles, such as version access role 460 and repository access role 468.

In operation 404, the data platform 102 defines one or more access roles based on the content of the application package 474. For example, when the application package 474 is created by a provider user, the data platform 102 creates an empty repository, such as repository 470, and an associated repository access role 468. When a new application version is added to the application package 474, the data platform 102 creates a version schema, such as version schema 486, and named storage location it to hold files of the corresponding version of the application. The data platform 102 creates an access role to access these materials, thus an application version gets its own access role. When an application, such as application 418, is accessed or executes code, the data platform 102 activates the appropriate roles, based upon the version of the application 418, giving the application 418 access to the resources used by the application 418.

In some examples, a shared content role 454 serves as a mechanism for managing access to shared resources within the application package 474 such as, but not limited to a shared schema 458 having one or more tables 456 that are shared by the provider account 492 with one or more consumer accounts. The shared content role 454 controls permissions and governs the visibility of shared content is visible in the application 418 as represented by shared schema 476 including one or more tables 478. The shared content role 454 is granted to specific components within installed applications of the application package 474 so that they may access shared content. The shared content role 454 provides that when the application 418 is installed in the consumer account 452, the shared resources are available according to the permissions defined by the provider user providing the application package 474. The shared content role 454 is useful in multi-consumer user environments where applications access common resources without compromising the isolation and security of individual consumer accounts. By leveraging this role, the data platform 102 can provide a controlled and secure method for sharing content for collaborative scenarios and for applications that use common datasets or services.

In some examples, a version access role 460 manages access to resources tied to specific versions within an application package 474. The version access role 460 provides that entities authorized to interact with a given version can do so, while maintaining isolation from other versions. The version access role 460 associates with resources such as schemas and scripts that are specific to a version of an application package 474. It controls interactions with these resources during deployment and execution of the application 418 and the one or more services 436 and functions 438 of the application 418. When updates occur or new versions of an application package are introduced, the version access role 460 facilitates access to the appropriate resources. The version access role 460 allows for application package lifecycle management within the data platform 102, enabling activities such as upgrades and maintenance while allowing consumer accounts to engage with the correct version of an application and related services and functions as determined by the permissions associated with the version access role 460.

In some examples, a repository access role 468 manages permissions for accessing container image repositories within the application package 474. This role is assigned to entities that interact with repositories containing the images used by applications, services, or functions. The repository access role 468 is used to access stored container images 488 used to create the services 436 and functions 438 of the service schema 434. The repository access role 468 governs the retrieval of images during the deployment and execution phases, ensuring that only authorized applications can pull the container images 488 for creation of the service schema 434. The repository access role 468 maintains the security and integrity of the application package 474 by controlling access to its container images 488.

In operation 406, the data platform 102 uses the version access role 460 to access the specification file 466 of the versioned schema 486. The data platform 102 executes the setup script 464 which creates the objects used by the application, which may include one or more compute pools 414, query warehouses 412, services 436 and functions 438 which may be utilized to access the services. When creating services 436, the setup script 464 contains instructions to configure compute pools 414, settings parameters and defining the environment in which services 436 will execute and assigning services to the created compute pools. The specification file 466 is referenced during the creation of a service 436, which indicates the container images and resources used by the service during execution. Additionally, the setup script 464 may define consumer access roles 494 with which it may grant access to the created services 436 and functions 438 to the application owner.

The access roles ensure that the one or more services 436 and functions 438 of the service schema 434 operate within the boundaries of their authorized capabilities, maintaining data security and integrity. The access roles act as gatekeepers, allowing the one or more services 436 and functions 438 of the service schema 434 to access those data objects that they have been explicitly permitted to access, thus preventing unauthorized data access or manipulation.

In some examples, one or more access roles are configured to be exclusive to the one or more services 436 and functions 438 and do not have associations with either a consumer user of the consumer account 452 or a provider user of the provider account 492. These exclusive roles are designed to facilitate specific interactions with and by the one or more services 436 and functions 438 of the service schema 434, ensuring that operations performed are within the scope of the one or more services 436 and functions 438 and are not influenced by external user permissions or privileges.

In some examples, an application primary role, such as application primary role 420, owns service objects, such as the one or more services 436, of the application 418 which prevents a consumer user from influencing the internal operations of the application 418.

In some examples, a consumer access role, such as a consumer access role of the one or more consumer access roles 494, allows a consumer user using the consumer account 452 access to specified objects of the application 418 and scopes the access to those specified objects.

In some examples, the exclusivity of the one or more application roles to the one or more services 436 and functions 438 allows for a controlled execution environment where the integrity of the execution of the service schema 434 is maintained. This design prevents unauthorized access or modifications to the service schema 434 by users who do not have the appropriate permissions, thereby upholding the security protocols established by the data platform 102 and protecting the integrity of the intellectual property of the provider user who created the application package 474.

In some examples, the design further provides that objects contained within the application 418 that have not had access granted through consumer access roles, remain hidden and inaccessible to the consumer user, protecting the provider's implementation and intellectual property.

In some examples, by restricting the one or more application roles to the objects of the service schema 434, the data platform 102 can enforce a clear separation of duties and access rights. This separation is useful in multi-tenant environments where services may be deployed across various consumer accounts, each with different users and access requirements. The exclusive roles ensure that each service operates independently of users' actions, providing a reliable and consistent execution of the functions of the service schema 434 as provided for by the application package 474.

In some examples, one or more compute pools 414 provide a dedicated environment for the execution of the service schema 434. When containers are commingled in a single compute pool, the services of the provider user could “attack” the services of the consumer user such as, but not limited to, trying to exfiltrate data or proprietary logic and, similarly, the services of the consumer user could do the same to the provider. In contrast to multiple services sharing a compute pool, for each application, the data platform 102 restricts a compute pool to a single application. This provides that the containers for the application are isolated from the consumer's services.

The one or more compute pools 414 operate as account-level constructs where jobs and services are executed. Compute pools 414 furnish the computational resources for the operation of long-running services and finite lifespan jobs.

The one or more compute pools 414 are created and configured by the setup script 464. The setup script 464 is responsible for defining the parameters of the one or more compute pools 414, such as the minimum and maximum number of nodes, thereby enabling the one or more compute pools 414 to scale according to the demands of the service schema 434. The configuration of the one or more compute pools 414 directly influences the performance and scalability of the one or more services 436. Once created, the one or more compute pools 414 host the one or more services 436 of the application 418 with access to CPUs, memory, and other system resources for execution. The one or more services 436 and functions 438, upon execution in the one or more compute pools 414, are capable of accessing data objects within the data platform 102 according to the one or more access roles, utilizing the resources of the one or more compute pools 414 to perform operations. In some examples, the one or more compute pools 414 are designed to isolate the one or more services 436, ensuring that the one or more services 436 execute within the compute pool 414 in a segregated manner from other services and resources not explicitly specified for the service schema 434 within the application 418. This isolation provides for maintaining the integrity and security of the service schema 434 and the one or more services 436.

In some examples, multiple services from different service schemas may be executed in the same compute pool. The segregation is between services in one app and the other services created by consumer user applications or different applications.

In some examples, the one or more query warehouses 412 serve as dedicated environments for executing SQL queries that are issued by the one or more services 436. These warehouses are provisioned with the compute resources to perform data processing tasks by the one or more services 436 of the service schema 434. In some examples, the setup script 464 may contain commands to instantiate the one or more query warehouses 412 with specific performance characteristics, such as warehouse size or compute power, tailored to the service schema 434. The setup script 464 provides that the one or more query warehouses 412 are associated with the service schema 434, allowing the service schema 434 to perform data operations within the context of the consumer account 452.

Once the one or more query warehouses 412 are created, the one or more services 436 and functions 438 can begin querying one or more objects of the data platform 102. The one or more services 436 utilize the query warehouses to execute SQL queries, leveraging the compute resources of the one or more query warehouses 412 to interact with databases, tables, or other data objects stored within the data platform 102. The one or more consumer access roles 494, which were created by the data platform 102 when the application was installed, govern the permissions used by the one or more services 436 and functions 438 of the service schema 434 to access and query these data objects.

An example command to create a service using the is illustrated below:

CREATE SERVICE my_service
IN COMPUTE POOL compute_pool
SPECIFICATION_FILE=‘specification_file.yaml’
MIN_INSTANCES=2
MAX_INSTANCES=2;

The create command creates a service within a compute pool and a specification file is referenced from a versioned schema using a schema access role. A specification file includes details such as the name of a container image and a path to the container image to be used to create the service that is hosted by a compute pool. In some examples, the specification file includes the configuration for the service, ensuring that one or more containers of the service operate with the correct settings and parameters.

In some examples, a setup script defines a minimum and maximum number of instances for a service. The service is executed within a compute pool with defined minimum and maximum number of instances. This determines the scaling behavior of the service within the compute pool.

In some examples, a consumer user can grant permissions to an application 418 to create query warehouses. A query warehouse created by the application 418 is owned by the application 418. The consumer user can take over ownership and control of the query warehouse to shut it down in an emergency.

In some examples, once the consumer user has granted an access role the ability to create a query warehouse to the application 418, the consumer user cannot control the number of query warehouses that the application creates. In some examples, the consumer user has no control over the size of the query warehouses created.

In some examples, a consumer user can programmatically create a query warehouse on behalf of the application 418. The consumer user can directly grant the query warehouse to the application 418. In some examples, the consumer user uses an API to directly communicate the name of the query warehouse to the application 418. In some examples, a query warehouse can be passed by reference to an application 418.

In some examples, a consumer user can grant permission to an application to create compute pools. Once created, the application owns the compute pool and can automatically adjust a size or configuration of the compute pool based upon workload. In some examples, application-owned compute pools cannot host services or executable objects from other application instances or from the consumer user.

In some examples, a consumer user creates a compute pool on behalf of an application. Such a compute pool is explicitly and exclusively dedicated to the application. In some examples, the compute pool is directly granted to the application for deploying services, using an API of the application.

In some examples, the architecture of the data platform incorporates stringent isolation measures within the compute pools to mitigate the risk of inter-service interference and potential security breaches. These measures are designed to prevent services that are executing concurrently in compute pools, from engaging in activities that could compromise the integrity of other services or lead to the unauthorized exposure of sensitive data or intellectual property.

In some examples, isolation is achieved through a combination of virtualization and access control mechanisms. Each container of a service runs in its own virtualized container, and a compute pool represents an isolated and virtualized environment in which these containers execute. One or more services may be hosted in a compute pool, but the containers of those services may directly communicate and see each other while services in other compute pools cannot do so without explicit permission through a RBAC system, effectively creating a sandbox that restricts the container of a service's operations to its own allocated resources. This virtualization provides that each container of a service has access to its own dedicated set of resources, such as CPU, memory, and storage, thereby eliminating the possibility of one container of a service consuming resources allocated to another container of a service. Furthermore, the data platform enforces access controls at the service level, which are defined by the one or more access roles associated with each service. These roles delineate the permissions and capabilities of the service, specifying which resources and data the service is authorized to access. The access roles are configured to prevent any service from accessing data or resources that are outside the scope of its defined permissions. In some examples, a capability of a service to access objects or resources is defined by access roles including, but not limited to, an application primary role 420, an application importer role 490, a version access role 460, and a repository access role 468. In some examples, one or more consumer access roles 494 define which entities can access the one or more services 436.

For example, a service that is authorized to access a particular database within the data platform will be unable to access another database that it has not been granted permissions for. Similarly, if a service attempts to perform operations that could potentially lead to the exposure of IP, such as accessing the underlying container images or source code of another service, the access control mechanisms will block such operations.

In some examples, as a service accesses underlying images that the service was deployed from and operates on the source code, protection of the IP of the provider user is provided for through the use of access roles. For example, provider user IP protection is provided by preventing a consumer user accessing the underlying images, guaranteed by a repository access role 468 which is not grantable to the consumer user. In some examples, the consumer user is prevented from deploying another service in the compute pool exclusive to an application, preventing consumer user created services from interfering with the services owned by the application.

In some examples, consumer IP protection is provided for by preventing services deployed by an application accessing container images or source code of another service owned by the consumer user if the consumer does not explicitly grant access to the application.

By implementing these isolation and access control measures, a data platform provides that services executing within compute pools are contained within their respective operational boundaries. This approach effectively prevents services from attacking each other, whether intentionally or unintentionally, and safeguards against the exposure of sensitive data and IP.

In operation 408, the one or more services 436 are executed in the one or more compute pools 414 and the one or more services 436 access objects of the application package 474 and of the data platform 102 using the one or more access roles.

In some examples, a data platform scans container images of a service for security vulnerabilities before a service is executed in a compute pool.

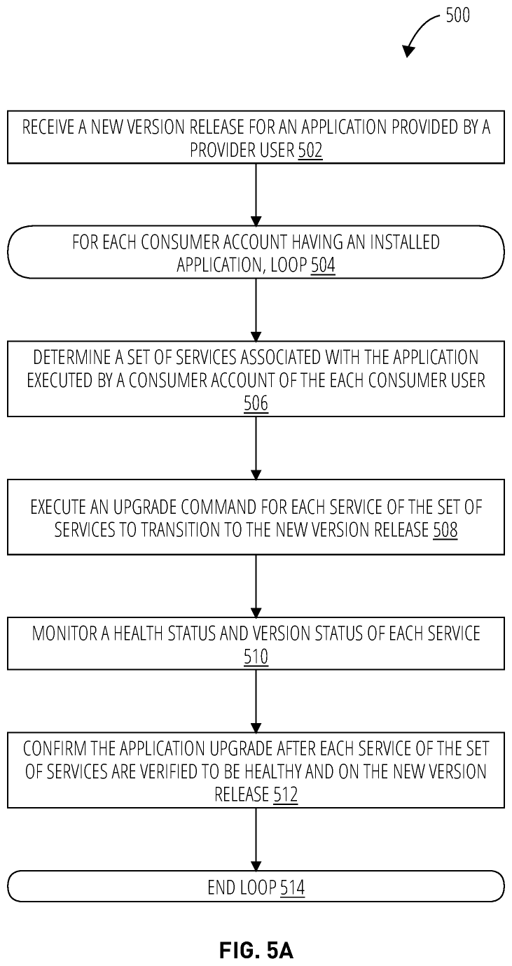

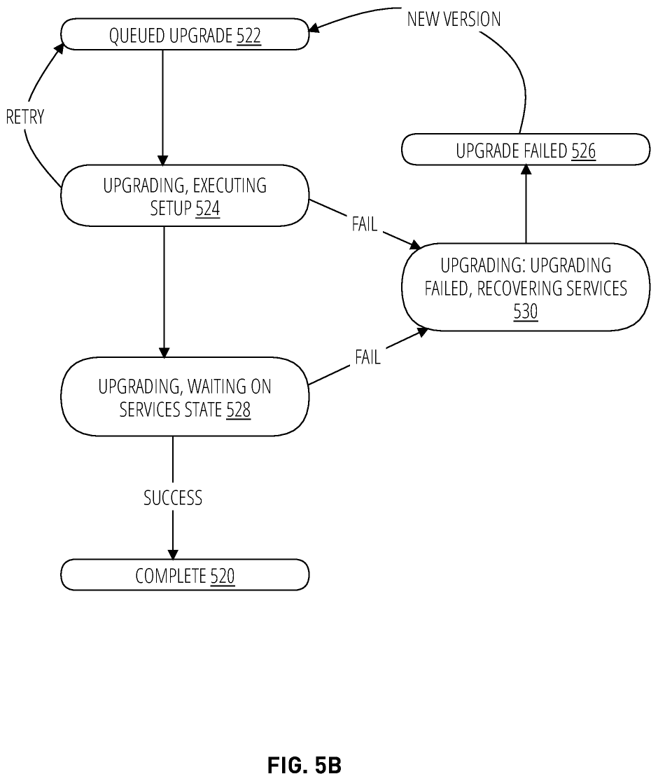

FIG. 5A illustrates an example application upgrade method 500 and FIG. 5B illustrates an example application upgrade state diagram of the application upgrade method 500, according to some examples. Although the example application upgrade method 500 depicts a particular sequence of operations, the sequence may be altered without departing from the scope of the present disclosure. For example, some of the operations depicted may be performed in parallel or in a different sequence that does not materially affect the function of the application upgrade method 500. In other examples, different components of a data platform 102 (of FIG. 1) that implements the application upgrade method 500 may perform functions at substantially the same time or in a specific sequence.

In some examples, a release directive functions as a command within the data platform 102 that initiates the deployment of a new version of an application. When a provider user decides to update an application, they issue a release directive that specifies the details of the new version to be deployed across consumer accounts. The release directive triggers the sequence of actions that constitute the upgrade workflow.

Upon issuance, the release directive activates the application upgrade method 500, which begins the process of transitioning consumer instances of the application to the new version. The application upgrade method 500 determines the set of services associated with the application and executes the commands to upgrade these services to the new version as specified by the release directive.

In some examples, the release directive also plays a role in scheduling the upgrade. The release directive includes parameters that allow for the upgrade to be delayed, providing consumer users with the flexibility to schedule the upgrade at a time that minimizes disruption to their operations.

In some examples, the data platform 102 uses a setup script such as, but not limited to setup script 464 (of FIG. 4B) to perform the upgrading operations of the application upgrade method 500. The setup script 464 executes a series of predefined instructions to transition an application from an older version to the new version. Upon the release of a new version of version an application, the corresponding setup script 464 is triggered, carrying out tasks such as altering service configurations, updating container specifications, and applying database schema changes. The setup script 464 is designed to interact with the RBAC system of the data platform 102, adjusting permissions and roles to align with the requirements of the new version.

During the upgrade, the setup script 464 is responsible for ensuring that components of the application are correctly configured to operate with the new features or changes. In some examples, the setup script 464 manages the deployment of these changes by executing SQL statements or scripts used for database updates and data migration. In some examples, the data platform 102 monitors the execution of the setup script, particularly the health and readiness of services, to confirm that they are capable of handling production traffic post-upgrade.

In some examples, if the data platform 102 encounters issues during the upgrade, the setup script 464 includes provisions for a rollback, enabling a swift reversion to a previous stable state of an application. This safety measure helps maintain service availability and data integrity.

In operation 502, the data platform 102 receives a new version for an application provided by a provider user and enters into a queued upgrade state 522. For example, when the data platform 102 receives a new version for an application provided by a provider user, the system initiates a sequence of events to upgrade installed applications to the new version of the application. In some examples, the data platform 102 validates the new version to ensure it meets predefined criteria for upgrades, such as compatibility checks and security validations.

The data platform 102 identifies consumer accounts currently utilizing the application and prepares them for the upgrade process. In some examples, this preparation includes additional operations such as, but not limited to, notifying account administrators of the impending upgrade, scheduling the upgrade to minimize disruption, and confirming that resources are available to support the upgrade process. The data platform 102 then manages the distribution of the new version across the consumer accounts, carefully monitoring the progress to quickly address any issues that arise during the deployment. This proactive approach ensures that the new version of the application is efficiently rolled out, while maintaining the integrity and stability of the consumer accounts.

In some examples, the data platform 102 manages the deployment of updates to minimize disruption to the consumer's operations by using rolling updates to ensure that the services of a consumer account remain available and responsive. In some examples, the data platform 102 monitors the rolling upgrades in real time, tracking the progress of each application's update and verifying that each step completes successfully before proceeding to the next.

In some examples, the data platform 102 applies the service specifications from a manifest associated with the upgrade or target version of the application. This process ensures that the services adhere to the predefined configurations and parameters used for their proper function. When initiating the upgrade, the data platform 102 references the manifest to retrieve the service specifications of the target version, which include various settings such as environment variables, resource limits, and version-specific configurations. These specifications allow the services to operate in alignment with the provider's design and the consumer's expectations. As the data platform 102 proceeds with the upgrade, the data platform 102 uses the target version service specifications as a baseline to configure the services. This ensures that any new instances of the services, or those being upgraded, are instantiated with the correct settings that are intended for the target version of the application.

In some examples, the data platform 102 provides an application state view to the provider user. This application state view is a comprehensive dashboard or interface that presents detailed information regarding the status of the application upgrade process for the application and its associated set of services. The application state view serves as a centralized monitoring tool for the provider user, offering visibility into various aspects of the upgrade process. It includes real-time updates on the progress of the upgrade, health indicators of the services, version statuses, and any anomalies or issues that may arise during the upgrade execution. As the upgrade progresses, the data platform 102 continuously updates the application state view with timely data. This includes marking milestones as they are achieved, such as the successful completion of readiness checks by a readiness probe, the transition of services to the new version, and the final confirmation of the upgrade. The application state view enables the provider user to track the upgrade's progress and to intervene if deemed useful. For example, if the application state view indicates a failure in upgrading a particular service, the provider user can quickly identify the issue and take corrective action, such as initiating a rollback or providing additional resources to facilitate the upgrade.

By providing an application state view with detailed status information, the application upgrade method 500 enhances the provider user's ability to manage and oversee the upgrade process effectively, ensuring a smooth transition to the new version of the application and maintaining service quality for the consumer users.

In operation 504 to operation 514, for each consumer account having an installation of the application, the data platform 102 performs a series of operations as follows.

In operation 506, the data platform 102 transitions to an executing upgrade state 524 and determines a set of services associated with the application executed within a consumer account. For example, the data platform 102 identifies the set of services associated with the application executed within a consumer account. This identification process involves the data platform 102 scanning the environment of the consumer account to catalog instances of services that are executing and linked to the application.

In some examples, the data platform 102 uses an integrated service registry and metadata repositories to accurately map out the network of services, taking into account their interdependencies, configurations, and current operational states. Once the set of services is determined, the data platform 102 assesses each service against the new version requirements, preparing an upgrade plan that outlines the steps for a successful transition. This plan includes instructions for upgrading service specifications, migrating data, and applying any new settings or parameters introduced in the new version. The data platform 102 ensures that the services are accounted for, thereby streamlining the upgrade process and reducing the risk of inconsistencies or oversights that could lead to service disruptions or degraded performance

In operation 508, the data platform 102 executes an upgrade command for each service of the set of services to transition to the new version. For example, the data platform 102 executes an upgrade command for each service of the set of services to transition to the new version. This execution involves the data platform 102 systematically issuing commands to each service, instructing them to initiate the upgrade process.

In some examples, a controlled rollout strategy is used, where each service is updated in a sequence that respects the dependencies and load balancing requirements of the overall application architecture.

In some examples, the data platform 102 orchestrates the upgrade in a manner that minimizes downtime, ensuring that at least a subset of the services remains operational to handle incoming requests. It also manages version consistency across the services, verifying that each service successfully migrates to the new version before proceeding to the next.

In some examples, in the event that a service encounters an issue during the upgrade, the data platform 102 can execute predefined rollback procedures or apply corrective measures to resolve the problem and continue the upgrade process.

In some examples, when the data platform 102 identifies a failure in the execution of the setup script while in the executing upgrade state 524, the application upgrade method 500 initiates a transition back to the queued upgrade state 522. This state is an intermediary phase where the application upgrade method 500 prepares to reattempt the upgrade. The transition to this state triggers the retry mechanism, which is designed to reinitiate the upgrading process. The data platform 102 employs this strategy to mitigate temporary issues that may have caused the initial upgrade attempt to fail, such as temporary network outages or transient resource constraints. During this retry operation, the application upgrade method 500 reassesses the environment to ensure that prerequisites for a successful upgrade are met before proceeding. The application upgrade method 500 verifies the integrity and readiness of the services, ensuring that they are in a stable state to undergo another upgrade attempt. The method also re-evaluates the health and version status of each service, as these are factors that determine the readiness of the services for the new version deployment.

In some examples, while in the executing upgrade state 524 if the application upgrade method 500 detects that a number of retry efforts have exceeded a threshold value of retry attempts, the application upgrade method 500 transitions to an upgrading failed state 530 and attempts to recover the services that were affected or altered by the upgrading process.

The upgrading failed state 530 signifies that the upgrade has not been successful and that action is recommended to be taken to address the affected services. The application upgrade method 500 initiates a recovery process aimed at restoring the services to their pre-upgrade state to ensure continued service availability and functionality.

In some examples, a selective recovery process is executed by the application upgrade method 500 that involves a nuanced approach that allows service providers to make informed decisions about how to handle service recovery during the application upgrade process. This process is tailored to address the specific needs of each service, particularly in the context of stateful and stateless services, as well as services that may be deliberately suspended by an application.

In some examples, for stateful services that have internal state persisted in the data platform 102 or locally, the recovery process reverts to the previous version's state if the upgrade fails. The provider can use the version initialization callback specified in the manifest (lifecycle_callbacks: version_init) to encapsulate the logic for both upgrading and reverting the state of these services. This callback is executed after the setup script and can be invoked again for recovery if the upgrade does not succeed, ensuring that the services are restored to their prior stable state.

In some examples, for stateless services or those that do not persist state, the selective recovery process may simply involve restarting the services with the previous version's configuration. Since these services do not have state upgrade concerns, the recovery process is more straightforward and can be managed through the setup script and version initialization callback without complex state management.

In some examples, suspended services present a unique challenge, as they may be intentionally inactive and should not be started unnecessarily during an upgrade. The selective recovery process for these services involves ignoring them during the upgrade monitoring, as they do not impact the active functionality of the application. However, if a suspended service is to be upgraded to avoid issues when it is later resumed, the provider can selectively choose to resume, upgrade, and then suspend the service again using the setup script and a system$wait_for_services function.

in some examples, The version initialization callback is a stored procedure that may optionally be declared in the manifest. The purpose of the callback is to start/initialize services, tasks, or other asynchronous activities associated with the version. Thus, the logic to alter the services and wait for their start are located within this callback. For example:

```
create or alter versioned schema callbacks;
create or replace procedure callbacks.version_init( )
  returns string
  language sql
as $$
  alter service services.svc1
    set specification_file = ‘/services/svc1.yaml’;
  alter service services.svc2
    set specification_file = ‘/services/svc2.yaml’;
  select system$wait_for_services(300, ‘services.svc1’,
‘services.svc2’);
$$;
```

The callback is invoked as follows: Upon successful completion of the setup script, the callback from the upgrading version is invoked, if the setup script fails, or the callback invoked after the successful upgrade script fails, the callback from the original version is invoked (service recovery).

A selective recovery process empowers providers with the flexibility to implement recovery operations that are best suited for each service's characteristics and the application's requirements. This approach aligns with the active and provider-centric recovery mechanisms where the data platform 102 adheres to service specifications and enables providers to maintain control over the upgrade and recovery process.

In some examples, the recovery process involves reverting the services to their last known good configuration, as specified in the manifest associated with the current version of the application. This action maintains the stability and operability of the application within the consumer account's environment. The data platform 102 oversees this recovery, monitoring the rollback of each service to confirm that they return to a healthy and operational state.

In some examples, the data platform 102 takes corrective action, which may include applying patches, adjusting configurations, or providing detailed guidance to a consumer user for manual intervention. In parallel, the platform may provide that the services of the consumer user continue to operate on the last known good configuration, maintaining service availability and data integrity.

In some examples, the data platform 102 logs the incident for review and learning purposes, contributing to the continuous improvement of the upgrade process.

In some examples, the application upgrade method 500 applies the original service specifications from the manifest of the current version to maintain consistency and stability across the application's lifecycle. This adherence to the manifest specifications is useful in scenarios where an upgrade may fail, and a rollback to the current version is implemented. The application upgrade method 500 can rely on the manifest to restore the services to their original state, as per the specifications, thus preserving the integrity and continuity of the application services for the consumer users.

In some examples, the data platform 102 maintains a current version of the application and its associated set of services in an operational state until the upgrade to the new version is confirmed. This maintenance ensures that there is no disruption in service for the consumer users while the upgrade process is underway. During the upgrade, the data platform 102 continuously monitors the set of services to ensure they remain healthy and functional. If the readiness probe indicates that the services are operating as expected, the method keeps them running on the current version. This approach provides a seamless experience for end-users, as they can continue to use the application without any noticeable changes or downtime. The data platform 102 transitions the services to the new version once the data platform 102 has verified that the upgraded services are ready to operate on the new version. By maintaining the current version until confirmation of the upgrade, the data platform 102 ensures a smooth and reliable upgrade process, minimizing the risk of service interruptions or degradation of application performance.

In some examples, the application upgrade method 500 isolates the issue to prevent it from affecting other ongoing operations or services within the environment of the consumer user. In some examples, the data platform 102 conducts an analysis to determine a cause of the upgrade failure, whether it be a configuration mismatch, resource constraint, or a compatibility issue with the existing setup of the consumer account.

At the end of the recovery process, the data platform 102 transitions to an upgrade failed state 526. In some examples, the data platform 102 transitions from the upgrade failed state 526 to the queued upgrade state 522 when a new version of the application is released. For example, if the data platform 102 failed to upgrade an application version of N+1 when N is the current version of the application and N+1 is the target version of the application, then the data platform 102 is in the upgrade failed state 526. Another upgrade attempt will be queued and the data platform 102 will transition to the queued upgrade state 522 if the provider user sets a release directive to version N+2. The data platform 102 will then proceed to process any queued application upgrades that may be waiting for resources.

In some examples, the data platform 102 assesses the impact of the failed upgrade on the overall application and its services. The data platform 102 ensures that any dependencies or interconnected components are taken into account during the recovery, thereby reducing a number of cascading failures that could arise from partial rollbacks.

In reference to the executing upgrade state 524, when the application upgrade method has executed the processes for upgrading the application to the target version of the application in operation 510, the data platform 102 transitions to a waiting on services state 528 and monitors a health status and version status of each service. For example, the data platform 102 monitors the health status and version status of each service by continuously evaluating the operational integrity and version conformity of each service against the expected outcomes of the new version.

In some examples, the data platform 102 employs a combination of health checks, readiness probes, and version verification protocols to ensure that each service not only starts up correctly but also aligns with the specification of a new version. The health status assessment includes checking for vital signs such as service responsiveness, resource utilization, error rates, and performance metrics, which indicate the ability of the service to handle workloads post-upgrade. Concurrently, the version status is confirmed by comparing the current operational parameters of the service with the defined attributes of the new version, confirming that the updates have been applied accurately. In some examples, the data platform 102 aggregates this information to provide real-time visibility into the upgrade's progress and to swiftly identify and remediate any anomalies that could impact the stability or functionality of the services.

In some examples, the readiness probe serves as a diagnostic tool within the data platform 102 that assesses the status of services during the upgrade process. The data platform 102 utilizes the readiness probe to determine whether each service has successfully transitioned to the new version and is fully operational. The readiness probe allows the performance checks to evaluate the health and readiness of the services. If a service responds positively to the probe's inquiries, it is marked as READY, indicating that the service is functioning correctly and can handle user requests. The data platform 102 relies on these responses to gauge the progress of the upgrade and to decide when the entire application upgrade can be confirmed as successful.

In the event that a service does not pass the readiness probe's checks within a defined timeframe, the data platform 102 interprets this as a failure to start. This triggers contingency protocols, such as retrying the upgrade or rolling back to the previous version, to ensure the reliability and availability of the application for consumer users.

The readiness probe provides real-time insights into the state of services, enabling the data platform 102 to make informed decisions and take appropriate actions to maintain service continuity during version transitions.

In some examples, the data platform 102 actively monitors services while in the waiting on services state 528. The data platform 102 continues this monitoring until the upgraded services either achieve a ready state or explicitly fail to start. The data platform 102 maintains this monitoring state for a duration up to a threshold upgrade wait time as defined in the manifest. If this time threshold is exceeded without the services becoming ready, the data platform 102 designates the upgrade as failed and transitions to an upgrading failed state 530, regardless of whether the services might later reach a ready state. In the upgrading failed state 530, the data platform 102 attempts to recover the services as previously described.

In some examples, a selective waiting process of the application upgrade method integrates a system$wait_for_services function into the setup script, enabling selective active monitoring of service upgrade status. The application upgrade method 500 continuously checks each service's status until containers reach a READY or FAILED state or a specified timeout expires. The function excludes suspended services from monitoring to avoid unnecessary startup or upgrade actions for services that are intentionally inactive.

If services do not become ready within the designated timeout, the function throws an exception, providing a detailed status report of the services in a JSON document. This document includes counts of container instances in READY, FAILED, or UNKNOWN states. Provider users can specify which services to monitor, allowing for targeted control over the upgrade process.

When a timeout or service failure occurs, the function uses the exception's error text as the upgrade failure reason, which promptly informs the provider user of the upgrade issue. This empowers provider users to script the upgrade process to halt automatically if services fail to start, thus preventing incomplete upgrades and ensuring service consistency.

An example script is illustrated below:

ALTER SERVICE services.svc1
SET SPECIFICATION_FILE = ‘/services/svc1.yaml’;
ALTER SERVICE services.svc2
SET SPECIFICATION_FILE = ‘/services/svc2.yaml’;
SELECT SYSTEM$WAIT_FOR_SERVICES(300, ‘services.svc1’,
‘services.svc2’);

An example of how this approach is particularly useful, is a provider user wants a service for upgrading is illustrated below:

```
ALTER SERVICE services.svc1
  SET SPECIFICATION_FILE = ‘/services/svc1.yaml’;
ALTER SERVICE services.svc2
  SET SPECIFICATION_FILE = ‘/services/svc2.yaml’
ALTER SERVICE services.svc2 RESUME;
BEGIN
SELECT SYSTEM$WAIT_FOR_SERVICES(300, ‘services.svc1’,
‘services.svc2’);
EXCEPTION
  ALTER SERVICE services.svc2 SUSPEND;
  RAISE;
END;
ALTER SERVICE services.svc2 SUSPEND;
```

In some examples, if any of the specified services fail to become ready within the provided timeout an exception will be thrown. For example, a body of the exception may be a document in a data-interchange format such as JavaScript Object Notation JSON or the like that is easy for humans to read and write and for machines to parse and generate. JSON document of the form:

```
[
  {
    ″schema″: <schema>,
    ″name″: <name>,
    ″overall_state″: [″FAILED”|″TIMEOUT″],
    ″containers″ : [
    {
      ″name″: <container_name>,
      ″ready″: <ready_count>,
      ″failed″: <failed_count>,
      ″unknown″: <unknown_count>
    }
  ]
```

Where:
Services that became ready are not included.
overall_state: A summarized determination made by the data platform 102 of the state of the service.
containers: The status of the individual containers within the service.
ready: The number of instances of the container in the READY state.
failed: The number of instances of the container in the FAILED state.
unknown: The number of instances of the container in the UNKNOWN state.

In some examples, a provider user may provide a script that makes fine-grained decisions on whether to fail the upgrade by catching this exception, parsing the JSON and refine their decision, otherwise the error text will become the upgrade_failure_reason that is conveyed to the provider user.

A selective waiting process enhances the control and adaptability provider users possess in managing application upgrades where the data platform 102 maintains operational stability and provides structured approaches for deploying new versions. The process provides for upgrades that are conducted transparently and under a provider user's management, enhancing the reliability and integrity of application services for consumer users.

In operation 512, the data platform 102 confirms the application upgrade after the services of the set of service containers are verified to be healthy and on the target version and transitions to the complete state 520. For example, the data platform 102 confirms that each service meets the health criteria established for normal operations and also reflects the updated features and improvements encapsulated in the target version. The platform cross-references the health and version status data collected during monitoring with the expected state of the upgraded services. Once the services pass these checks, the data platform 102 finalizes the upgrade by marking it as successful in the system records.

In some examples, the data platform 102 updates relevant system components and consumer-facing documentation to reflect the new version's availability.

In some examples, the data platform 102 notifies a provider user upon the successful completion of an application upgrade. This notification process is a part of the upgrade workflow, serving as a confirmation that the new version of the application has been deployed across the consumer accounts without any issues.

Once the data platform 102 has verified that the services are healthy and operating on the new version, it generates a notification message. This message is then communicated to the provider user, providing them with the assurance that the upgrade process has been executed as planned and that the application is now running the new version. The notification to the provider user can take various forms, such as an email, a dashboard update, or an entry in an application state view. It includes details about the upgrade, such as the version number of the new release, the time of completion, and any relevant metrics or logs that were collected during the upgrade process. By providing this notification, the data platform 102 closes the loop on the upgrade process, allowing the provider user to proceed with post-upgrade activities, such as analyzing the performance of the new version or communicating the successful upgrade to stakeholders. This proactive communication by the data platform 102 enhances transparency and trust in the upgrade process within the data platform 102.

In some examples, the data platform 102 triggers any post-upgrade processes, such as cache invalidation, re-indexing, or other housekeeping tasks used to optimize the performance of the upgraded services. Additionally, the data platform 102 may notify both the provider user and the consumer users of the successful upgrade, providing details on the new capabilities and any action items remaining to be performed by a consumer user or a provider user.

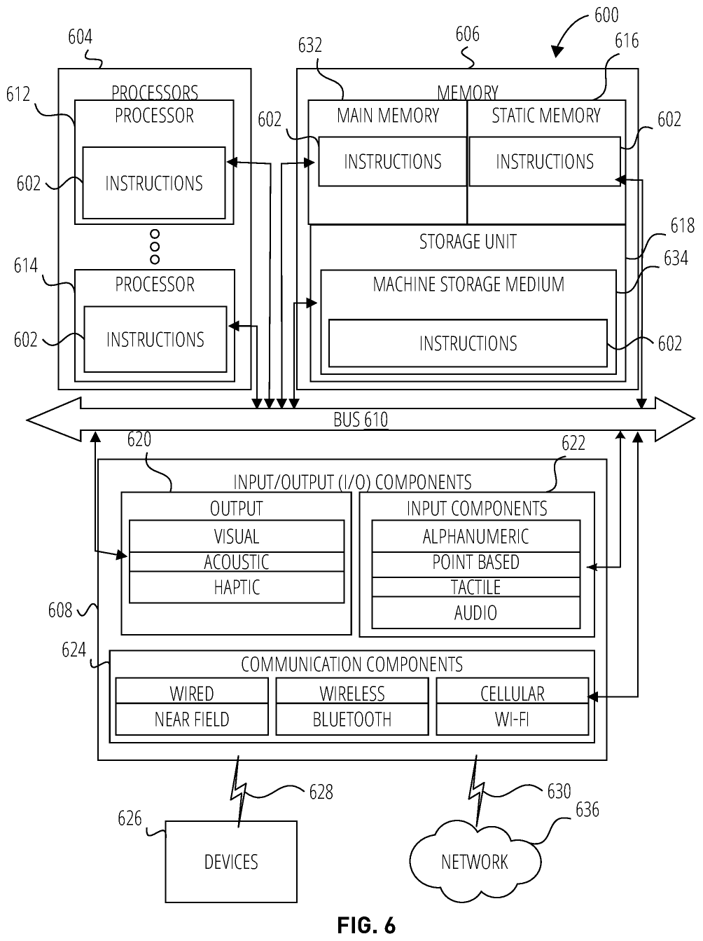

FIG. 6 illustrates a diagrammatic representation of a machine 600 in the form of a computer system within which a set of instructions may be executed for causing the machine 600 to perform any one or more of the methodologies discussed herein, according to examples. Specifically, FIG. 6 shows a diagrammatic representation of the machine 600 in the example form of a computer system, within which instructions 602 (e.g., software, a program, an application, an applet, an application, or other executable code) for causing the machine 600 to perform any one or more of the methodologies discussed herein may be executed. For example, the instructions 602 may cause the machine 600 to execute any one or more operations of any one or more of the methods described herein. In this way, the instructions 602 transform a general, non-programmed machine into a particular machine 600 (e.g., the compute service manager 104, the execution platform 110, and the data storage devices 1 to N of data storage 106) that is specially configured to carry out any one of the described and illustrated functions in the manner described herein.

In alternative examples, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 602, sequentially or otherwise, that specify actions to be taken by the machine 600. Further, while only a single machine 600 is illustrated, the term “machine” shall also be taken to include a collection of machines that individually or jointly execute the instructions 602 to perform any one or more of the methodologies discussed herein.

The machine 600 includes hardware processors 604, memory 606, and I/O components 608 configured to communicate with each other such as via a bus 610. In some examples, the processors 604 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 612 and a processor 614 that may execute the instructions 602. The term “processor” is intended to include multi-core processors that may comprise two or more independent processors (sometimes referred to as “cores”) that may execute instructions 602 contemporaneously. Although FIG. 6 shows multiple processors 604, the machine 600 may include a single processor with a single core, a single processor with multiple cores (e.g., a multi-core processor), multiple processors with a single core, multiple processors with multiple cores, or any combination thereof.

The memory 606 may include a main memory 632, a static memory 616, and a storage unit 618 including a machine storage medium 634, accessible to the processors 604 such as via the bus 610. The main memory 632, the static memory 616, and the storage unit 618 store the instructions 602 embodying any one or more of the methodologies or functions described herein. The instructions 602 may also reside, completely or partially, within the main memory 632, within the static memory 616, within the storage unit 618, within at least one of the processors 604 (e.g., within the processor's cache memory), or any suitable combination thereof, during execution thereof by the machine 600.

The input/output (I/O) components 608 include components to receive input, provide output, produce output, transmit information, exchange information, capture measurements, and so on. The specific I/O components 608 that are included in a particular machine 600 will depend on the type of machine. For example, portable machines such as mobile phones will likely include a touch input device or other such input mechanisms, while a headless server machine will likely not include such a touch input device. It will be appreciated that the I/O components 608 may include many other components that are not shown in FIG. 6. The I/O components 608 are grouped according to functionality merely for simplifying the following discussion and the grouping is in no way limiting. In various examples, the I/O components 608 may include output components 620 and input components 622. The output components 620 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 622 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 608 may include communication components 624 operable to couple the machine 600 to a network 636 or devices 626 via a coupling 630 and a coupling 628, respectively. For example, the communication components 624 may include a network interface component or another suitable device to interface with the network 636. In further examples, the communication components 624 may include wired communication components, wireless communication components, cellular communication components, and other communication components to provide communication via other modalities. The devices 626 may be another machine or any of a wide variety of peripheral devices (e.g., a peripheral device coupled via a universal serial bus (USB)). For example, as noted above, the machine 600 may correspond to any one of the compute service manager 104, the execution platform 110, and the devices 626 may include the data storage device 226 or any other computing device described herein as being in communication with the data platform 102 or the data storage 106.

The various memories (e.g., 606, 616, 632, and/or memory of the processor(s) 604 and/or the storage unit 618) may store one or more sets of instructions 602 and data structures (e.g., software) embodying or utilized by any one or more of the methodologies or functions described herein. These instructions 602, when executed by the processor(s) 604, cause various operations to implement the disclosed examples.

Described implementations of the subject matter can include one or more features, alone or in combination as illustrated below by way of example:

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 636 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 636 or a portion of the network 636 may include a wireless or cellular network, and the coupling 630 may be a Code Division Multiple Access (CDMA) connection, a Global System for Mobile communications (GSM) connection, or another type of cellular or wireless coupling. In this example, the coupling 630 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 602 may be transmitted or received over the network 636 using a transmission medium via a network interface device (e.g., a network interface component included in the communication components 624) and utilizing any one of a number of well-known transfer protocols (e.g., hypertext transfer protocol (HTTP)). Similarly, the instructions 602 may be transmitted or received using a transmission medium via the coupling 628 (e.g., a peer-to-peer coupling) to the devices 626. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 602 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Described implementations of the subject matter can include one or more features, alone or in combination as illustrated below by way of example.

Example 1 is a machine-implemented method comprising: receiving a new version for an application provided by a provider user; and for each consumer user using the application, performing application upgrade operations comprising: determining a set of services associated with the application executed by a consumer account of the each consumer user; executing an upgrade command for each service of the set of services to transition to the new version; monitoring a health status and version status of each service; and confirming the application upgrade after each service of the set of services are verified to be healthy and on the new version.

In Example 2, the subject matter of Example 1 includes, wherein the application upgrade operations further comprise: providing a notification to the provider user when the application upgrade is complete.

In Example 3, the subject matter of any of Examples 1-2 includes, wherein the application upgrade operations further comprise: delaying the application upgrade to allow a consumer user to schedule the application upgrade for a respective consumer account within a specified delay time.

In Example 4, the subject matter of any of Examples 1-3 includes, wherein monitoring the health of each service comprises: utilizing a readiness probe to determine the health status.

In Example 5, the subject matter of any of Examples 1-4 includes, wherein the application upgrade operations further comprise: maintaining a current version of the application and the set of services in an operational state until the application upgrade is confirmed.

In Example 6, the subject matter of any of Examples 1-5 includes, wherein the application upgrade operations further comprise: reverting to a previous version of the application and the set of services in a case of an application upgrade failure.

In Example 7, the subject matter of any of Examples 1-6 includes, wherein the application upgrade operations further comprise: applying original service specifications from a manifest associated with a current version of the application.

In Example 8, the subject matter of any of Examples 1-7 includes, wherein confirming the application upgrade comprises: setting a wait time threshold for the set of services to upgrade; and determining the application upgrade failed when a wait time has exceeded the wait time threshold.

In Example 9, the subject matter of any of Examples 1-8 includes, wherein the application upgrade is performed as part of a release directive issued to begin deploying the new version of the application.

In Example 10, the subject matter of any of Examples 1-9 includes, wherein the application upgrade operations further comprise: providing an application state view to the provider user, the application state view including details about a status of the application upgrade of the application and the set of services.

Example 11 is at least one machine-readable medium including instructions that, when executed by processing circuitry, cause the processing circuitry to perform operations to implement any of Examples 1-10.

Example 12 is an apparatus comprising means to implement any of Examples 1-10.

Example 13 is a system to implement any of Examples 1-10.

Example 14 is a method to implement any of Examples 1-10.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A machine-implemented method comprising:
receiving a new version for an application provided by a provider user; and
for each consumer user using the application, performing application upgrade operations comprising:
determining a set of services associated with the application executed by a consumer account of the each consumer user;
executing an upgrade command for each service of the set of services to transition to the new version;
monitoring a health status and version status of each service; and
confirming the application upgrade after each service of the set of services are verified to be healthy and on the new version.

2. The machine-implemented method of claim 1, wherein the application upgrade operations further comprise:
providing a notification to the provider user when the application upgrade is complete.

3. The machine-implemented method of claim 1, wherein the application upgrade operations further comprise:
delaying the application upgrade to allow a consumer user to schedule the application upgrade for a respective consumer account within a specified delay time.

4. The machine-implemented method of claim 1, wherein monitoring the health of each service comprises:
utilizing a readiness probe to determine the health status.

5. The machine-implemented method of claim 1, wherein the application upgrade operations further comprise:
maintaining a current version of the application and the set of services in an operational state until the application upgrade is confirmed.

6. The machine-implemented method of claim 5, wherein the application upgrade operations further comprise:
reverting to a previous version of the application and the set of services in a case of an application upgrade failure.

7. The machine-implemented method of claim 1, wherein the application upgrade operations further comprise:
applying original service specifications from a manifest associated with a current version of the application.

8. The machine-implemented method of claim 1, wherein confirming the application upgrade comprises:
setting a wait time threshold for the set of services to upgrade; and
determining the application upgrade failed when a wait time has exceeded the wait time threshold.

9. The machine-implemented method of claim 1, wherein the application upgrade is performed as part of a release directive issued to begin deploying the new version of the application.

10. The machine-implemented method of claim 1, wherein the application upgrade operations further comprise:
providing an application state view to the provider user, the application state view including details about a status of the application upgrade of the application and the set of services.

11. A system comprising:
at least one processor; and
at least one memory storing instructions that, when executed by the at least one processor, cause the system to perform operations comprising:
receiving a new version for an application provided by a provider user; and
for each consumer user using the application, performing application upgrade operations comprising:
determining a set of services associated with the application executed by a consumer account of the each consumer user;
executing an upgrade command for each service of the set of services to transition to the new version;
monitoring a health status and version status of each service; and
confirming the application upgrade after each service of the set of services are verified to be healthy and on the new version.

12. The system of claim 11, wherein the application upgrade operations further comprise:
providing a notification to the provider user when the application upgrade is complete.

13. The system of claim 11, wherein the application upgrade operations further comprise:
delaying the application upgrade to allow a consumer user to schedule the application upgrade for a respective consumer account within a specified delay time.

14. The system of claim 11, wherein monitoring the health of each service comprises:
utilizing a readiness probe to determine the health status.

15. The system of claim 11, wherein the application upgrade operations further comprise:
maintaining a current version of the application and the set of services in an operational state until the application upgrade is confirmed.

16. The system of claim 15, wherein the application upgrade operations further comprise:
reverting to a previous version of the application and the set of services in a case of an application upgrade failure.

17. The system of claim 11, wherein the application upgrade operations further comprise:
applying original service specifications from a manifest associated with a current version of the application.

18. The system of claim 11, wherein confirming the application upgrade comprises:
setting a wait time threshold for the set of services to upgrade; and
determining the application upgrade failed when a wait time has exceeded the wait time threshold.

19. The system of claim 11, wherein the application upgrade is performed as part of a release directive issued to begin deploying the new version of the application.

20. The system of claim 11, wherein the application upgrade operations further comprise:
providing an application state view to the provider user, the application state view including details about a status of the application upgrade of the application and the set of services.

21. A machine-storage medium storing instructions that, when executed by one or more processors of a system, cause the system to perform operations comprising:
receiving a new version for an application provided by a provider user; and
for each consumer user using the application, performing application upgrade operations comprising:
determining a set of services associated with the application executed by a consumer account of the each consumer user;
executing an upgrade command for each service of the set of services to transition to the new version;
monitoring a health status and version status of each service; and
confirming the application upgrade after each service of the set of services are verified to be healthy and on the new version.

22. The machine-storage medium of claim 21, wherein the application upgrade operations further comprise:
providing a notification to the provider user when the application upgrade is complete.

23. The machine-storage medium of claim 21, wherein the application upgrade operations further comprise:
delaying the application upgrade to allow a consumer user to schedule the application upgrade for a respective consumer account within a specified delay time.

24. The machine-storage medium of claim 21, wherein monitoring the health of each service comprises:
utilizing a readiness probe to determine the health status.

25. The machine-storage medium of claim 21, wherein the application upgrade operations further comprise:
maintaining a current version of the application and the set of services in an operational state until the application upgrade is confirmed.

26. The machine-storage medium of claim 25, wherein the application upgrade operations further comprise:
reverting to a previous version of the application and the set of services in a case of an application upgrade failure.

27. The machine-storage medium of claim 21, wherein the application upgrade operations further comprise:
applying original service specifications from a manifest associated with a current version of the application.

28. The machine-storage medium of claim 21, wherein confirming the application upgrade comprises:
setting a wait time threshold for the set of services to upgrade; and
determining the application upgrade failed when a wait time has exceeded the wait time threshold.

29. The machine-storage medium of claim 21, wherein the application upgrade is performed as part of a release directive issued to begin deploying the new version of the application.

30. The machine-storage medium of claim 21, wherein the application upgrade operations further comprise:
providing an application state view to the provider user, the application state view including details about a status of the application upgrade of the application and the set of services.
